(19) United States
(12) Patent Application Publication
(10) Pub. No.: US 2005/0014415 A1
(43) Pub. Date: Jan. 20, 2005

(54) Electrical connector

(76) Inventors: Shu-Chen Yang, Tu-Chen (TW); Hsien-Chu Lin, Tu-chen (TW); Yung Chien Chung, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/894,727

(22) Filed: Jul. 19, 2004

(30) Foreign Application Priority Data
Jul. 18, 2003 (TW) 92213185

(51) Int. Cl. H01R 13/58

(52) U.S. Cl. 439/578

(57) ABSTRACT

An electrical connector (1) mates with a complementary connector for transmitting signals. The electrical connector includes a metallic shell (10), a conductive contact (12) and an insulative housing (11) sandwiched between the shell and the conductive contact for retaining the conductive contact. The metallic shell includes a mating portion (101) and a base portion (102) extending from the base portion. A projection (103) integrally protrudes outwardly from the mating portion adjacent to the base portion for engaging with the complementary connector. The mating portion includes a plurality of slits (106) defined therethrough.

### BACKGROUND OF THE INVENTION

1. Field of the Invention

The present invention generally relates to an electrical connector, and more particularly to a radio frequency connector.

2. Description of Prior Art

Coaxial interconnection systems, such as radio frequency (RF) interconnection systems are well known in the art. For example FIGS. 1 and 2 disclose a conventional connector comprising a shell 10′, a conductive contact 12′ received in the shell 10′ and an insulative housing 11′ between the shell 10′ and the conductive contact 12′ for holding the conductive contact 12′ and a ferrule 13′. The shell 10′ includes a first portion 101′ mating with a complementary connector and a second portion 102′ extending from the first portion 101′. The ferrule 13′ is secured to an outer surface of the first portion 101′ for engaging with the complementary connector. However, the ferrule 13′ is a sole component separated with the first portion 101′ so that the structure of the connector is complex to assemble and manufacture. Furthermore, the first portion 101′ is rigid so that when the first portion 101′ mates with the complementary connector, there is a large friction force between the first portion 101′ and the complementary connector which not to be easily inserted into, pull out and engaged in the complementary connector.

U.S. Pat. No. 5,074,809, issued to Rousseau on Dec. 24, 1991 discloses a connector element comprises a dielectric sleeve that axially accommodates a conductor, which may be female, and peripherally an outer conductor including a rigid zone followed by a nose, the solid beginning of which rests on a bearing surface of the dielectric sleeve, while the subsequent slit portion of it terminates at an outer lateral chamfered edge provided with two chamfers connected by a flat side. This flat side assures electrical continuity, while the remainder of the nose enables guidance and elastic retention in a homologous hole of the other connector. However, the outer lateral chamfered edge is formed on a free end of the nose, when the connector element mating with a complementary connector, the nose has a larger transverse distortion so that the connector element can not reliably capture with the complementary connector.

Hence, an improved connector is needed to eliminate the above-mentioned defects of the conventional connectors.

### BRIEF SUMMARY OF THE INVENTION

A main object of the present invention is to provide an electrical connector having a simple structure to manufacture.

Another object of the present invention is to provide an electrical connector with a relative flimsy portion preventing the electrical connector separating from the complementary connector.

An electrical connector according to the present invention mates with a complementary connector for transmitting signals. The electrical connector includes a metallic shell, a conductive contact and an insulative housing sandwiched between the shell and the conductive contact for retaining the conductive contact. The metallic shell includes a base portion and a mating portion extending from the base portion. A projection integrally protrudes outwardly from the mating portion adjacent to the base portion for engaging with the complementary connector. The mating portion includes a plurality of slits defined therethrough.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded view of a conventional electrical connector.

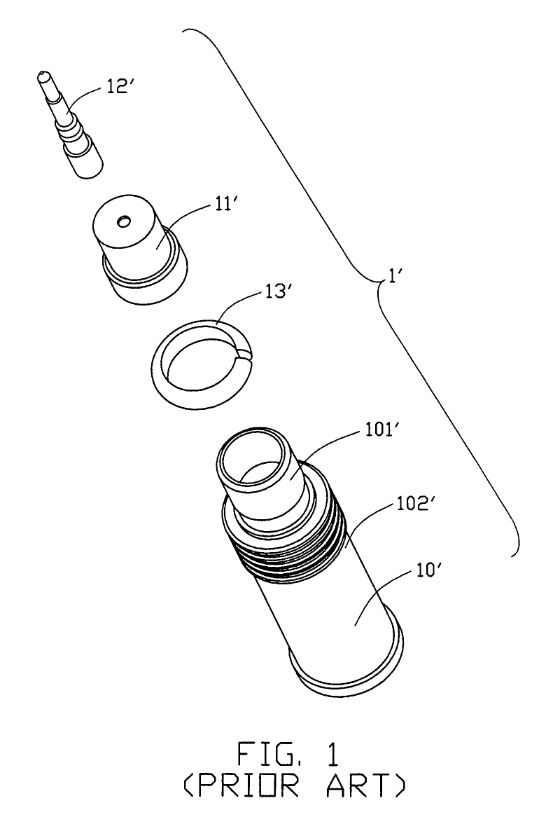

FIG. 2 is an assembled view of the conventional electrical connector of FIG. 1.

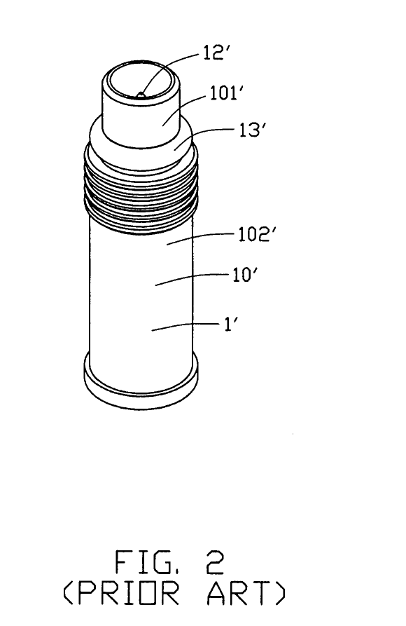

FIG. 3 is an exploded view of an electrical connector in accordance with the present invention.

FIG. 4 is an assembled view of the electrical connector of FIG. 3.

FIG. 5 is a cross-sectional view taken along a line 5-5 of FIG. 4.

### DETAILED DESCRIPTION OF THE INVENTION

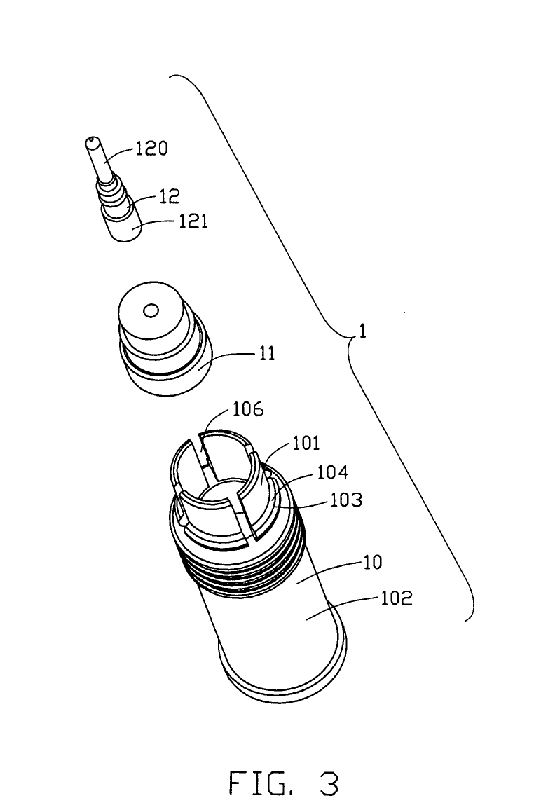

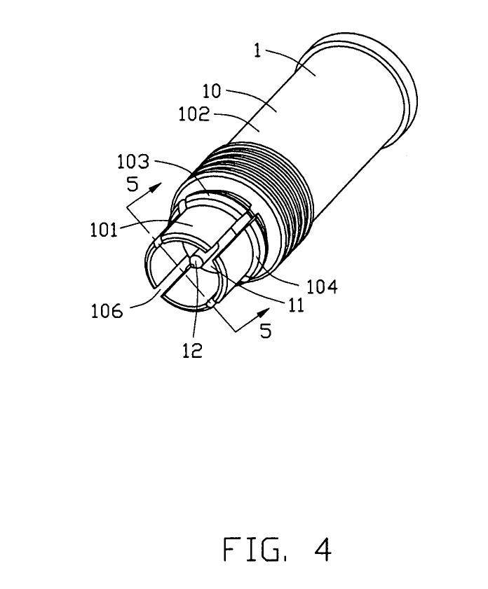

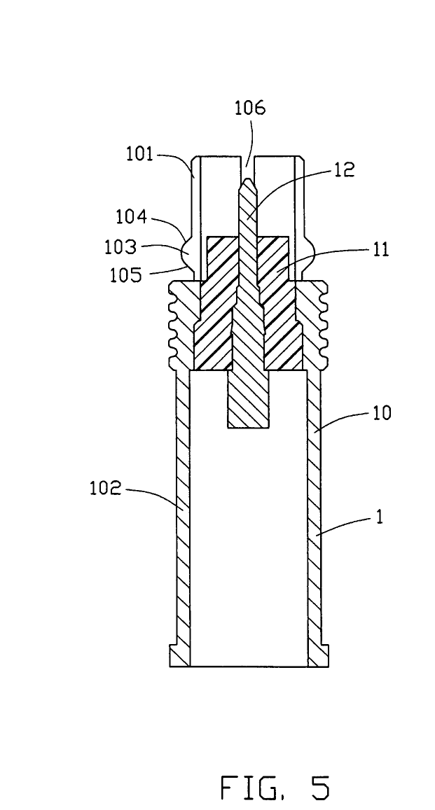

Referring to FIGS. 3 to 5, an electrical connector 1 of the present invention for mating with a complementary connector (not shown), comprises a hollow cylindrical shell 10, a conductive contact 12 received in the shell 10 and an insulative housing 11 between the shell 10 and the conductive contact 12 for holding the conductive contact 12.

The shell 10 is metallic and encloses on a periphery wall of the housing 11. The shell 10 includes a mating portion 101 with a smaller diameter and a base portion 102 with a larger diameter extending rearwardly from the mating portion 101. An annular projection 103 integrally protrudes outwardly from an outer surface of a rear end of the mating portion 101 adjacent to the base portion 102. The annular projection 103 has a declining leading surface 104 away from the base portion 102 and an engaging surface 105 adjacent to the base portion 102. A plurality of slits 106 are defined through the mating portion 101. The annular projection 103 is separated into a plurality of flanges (not labeled) by the slits 106.

The insulative housing 11 is fixed in the shell 10 and retaining the conductive contact 12. The conductive contact 12 includes a mounting portion 120 retained by the insulative housing 11 and a conductive contacting portion 121 extending from the mounting portion 120. A free end of the mounting portion 120 is soldered to an inner core of a coaxial cable (not shown).

In mating process, the mating portion 101 of the electrical connector 1 is inserted into the complementary connector until the annular projection 103 retains with a corresponding groove of the complementary connector. The conductive contact 12 mechanically and electrically connects with the mating contact of the complementary connector. Since the annular projection 103 is formed on the rear end of the mating portion 101 adjacent to the base portion 102. When the mating portion 101 mates with the complementary connector, the annular projection 103 has a little transverse distortion so that the annular projection 103 can reliably capture with the complementary connector. Furthermore, the annular projection 103 integrally protrudes from the mating portion for easily manufacturing.

It is to be understood, however, that even though numerous, characteristics and advantages of the present invention have been set forth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. An electrical connector, comprising:
a shell including a base portion and a mating portion extending from the base portion, a projection protruding outwardly from the mating portion adjacent to the base portion;
an insulative housing received in the shell; and
a conductive contact retained in the housing.

2. The electrical connector as claimed in claim 1, wherein the shell is substantially hollow cylindrical shaped, the base portion is rigid and the mating portion is semi-rigid.

3. The electrical connector as claimed in claim 1, wherein the projection integrally protrudes outwardly from an outer surface of the mating portion.

4. The electrical connector as claimed in claim 3, wherein the mating portion defines a plurality of slits therethrough.

5. The electrical connector as claimed in claim 4, wherein the projection is separated into a plurality of flanges by the slits.

6. An electrical connector adapted to mate with a complementary connector, comprising:
a metallic shell including a base portion and a mating portion extending from the base portion, a projection protruding outwardly from the mating portion adjacent to the base portion, and the mating portion defining a plurality of slits therethrough;
an insulative housing received in the shell; and
a conductive contact retained in the housing.

7. The electrical connector as claimed in claim 6, wherein the shell is substantially hollow cylindrical shaped, the base portion is rigid and the mating portion is semi-rigid.

8. The electrical connector as claimed in claim 6, wherein the projection integrally protrudes outwardly from an outer surface of the mating portion.

9. The electrical connector as claimed in claim 6, wherein the projection is separated into a plurality of flanges by the slits.

10. An electrical connector, comprising:
a metallic shell including a base portion and a tubular mating portion axially extending from the base portion with at least one axially extending slit therein, a circumferential projection protruding radially and outwardly from the mating portion adjacent to the base portion and far away from a distal end of said mating portion and interrupted by said at least one slit;
an insulative housing received in the shell; and
a conductive contact disposed in the housing.
